(19) United States
(12) Patent Application Publication
(10) Pub. No.: US 2007/0035521 A1
(43) Pub. Date: Feb. 15, 2007

(54) Open virtual input and display device and method thereof

(76) Inventors: Ping-Chang Jui, Taipei (TW); Ruey-Nan Yeh, Taoyuan (TW); Ching-Wen Yu, Taipei (TW)

Correspondence Address: HARNESS, DICKEY & PIERCE, P.L.C., P.O. BOX 8910, RESTON, VA, 20195, US

(21) Appl. No.: 11/200,074

(22) Filed: Aug. 10, 2005

(51) Int. Cl. G09G 5/00

(52) U.S. Cl. 345/168

(57) ABSTRACT

An open virtual input and display device and method thereof, in which a micro project module projects various input interface images; at the same time a detecting light source emit module emits a detecting beam above an image frame; based upon the reflective beam, a detecting light source receive module acquires the input action of a user on the image; a recognition module converts the acquired input action into an operation command with a recognition function; a switch module transforms and loads the corresponding input interface image data and the recognition function according to the operation command; and an application information database is used to store multiple application information files.

### BACKGROUND OF THE INVENTION

1. Field of the Invention

The present invention relates to an open virtual input and display device and method thereof, and particularly to an open design which makes a single hardware act as many different virtual input and display devices creating a variety of applications.

2. Description of the Related Art

Nowadays, high technology products are generally required to be smaller in size. However, the purpose of making some articles small in size is for easy to take with, but the small size became a problem for the user to use. Take a keyboard or keys as an typical example, the keyboard which is small in size can save space of the table, but it is likely for a user to press the adjacent keys while typing; and for the keys, the small keys result in a small volume of the entire product, but it is inconvenient for a user to press a key and likely for a user to press the wrong key or two keys simultaneously.

To eliminate this problem, some people bring forward a virtual keyboard method, which utilizes a hologram or optical scanning manner to produce a “fixed” keyboard image, a detecting beam to detect an operation command input made by the user utilizing the virtual keyboard, thereby the user can obtain the effect of the keyboard input carrying only a projection device which makes it possible to do the typing silently. In addition, the user doesn't have to worry about the breakdown of the keyboard, and can place this device anywhere to input.

This kind of product is commercially available, but it is expensive compared to the traditional keyboard. Obviously, it is not an attractive product for the user. The problem worth considering lies in how to find out a high additional value under its basic hardware architecture.

### SUMMARY OF THE INVENTION

In view of the above-mentioned problem, the object of the present invention is to provide an open virtual input and display device and method thereof, which projects various images in a conventional pairing manner using together with multiple application information files and sensing the inputting of the user, thereby achieving the effect of multiple virtual controllers, and increasing the additional value.

Accordingly, to achieve the above object, a system of the present invention comprises:

A micro project module for projecting input interface images of various master devices; a detecting light source emit module for emitting a detecting beam above an image frame; a detecting light source receive module for receiving a reflected beam to acquire the input action of a user on the projection image; a recognition module for determining a coordinate position of a reflective point and bringing the coordinate position of the input action in a recognition function and converting the action into an operation command; a switch module for transforming a corresponding application information file according to the operation command, wherein each application information file further comprises an input interface image data and its corresponding recognition function; and an application information database for storing multiple application information files.

In order to make the present invention to be an input device of various master devices, the method comprises the following steps: first detecting the master devices which are available for setting up; setting up the present invention as one of the devices for inputting the operation command by each of the master devices; then projecting a basic menu image for switching the master devices; afterward receiving a master device option selected by the user, and establishing a pairing connection with the master device; finally switching to project the input interface image of the master device.

After pairing a variety of master devices, the method of the present invention used for a virtual input interface device comprises the following steps: first projecting an input interface image of a visible light onto a physical plane, and activating a detection of the detecting beam above the image; subsequently receiving the operation command input by the user above the image; after recognizing an instruction input by the user, determining whether the projection image should be changed; if yes, searching a corresponding application information file from the application information database for loading, and then transforming the projected image and its corresponding recognition function; otherwise delivering the received operation command to the master device, such that the master device takes the corresponding action.

The characteristics and practices associated with the present invention in combination with the drawings are illustrated as the most preferred embodiment in detail as follows.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an architecture view of the system of the present invention;

FIG. 2 is a schematic view of the present invention applied to a multimedia player;

FIG. 3 is a schematic view of the present invention applied to a portable mobile device;

FIG. 4 is a schematic view of the present invention applied to a personal digital assistant;

FIG. 5 is a schematic view of the present invention used for recognizing the relationship between a small unit block and a key;

FIG. 6 is a function comparison table of the present invention;

FIG. 7 is a flowchart of setting up a master device display according to the method of the present invention; and

FIG. 8 is a flowchart of the method of the present invention used as an input device to project.

### DETAILED DESCRIPTION OF THE INVENTION

The present invention discloses an open virtual input and display device and method thereof. In the following detail description of the invention, many specific details are described to provide a full description of the present invention. However, it is known to those skilled in the art that the present invention can be implemented without those specific details, or can be implemented by utilizing alternative elements or methods. In other cases, to avoid confusion of the key point of the present invention, the known methods, procedures, parts, and circuits are not described in particular details.

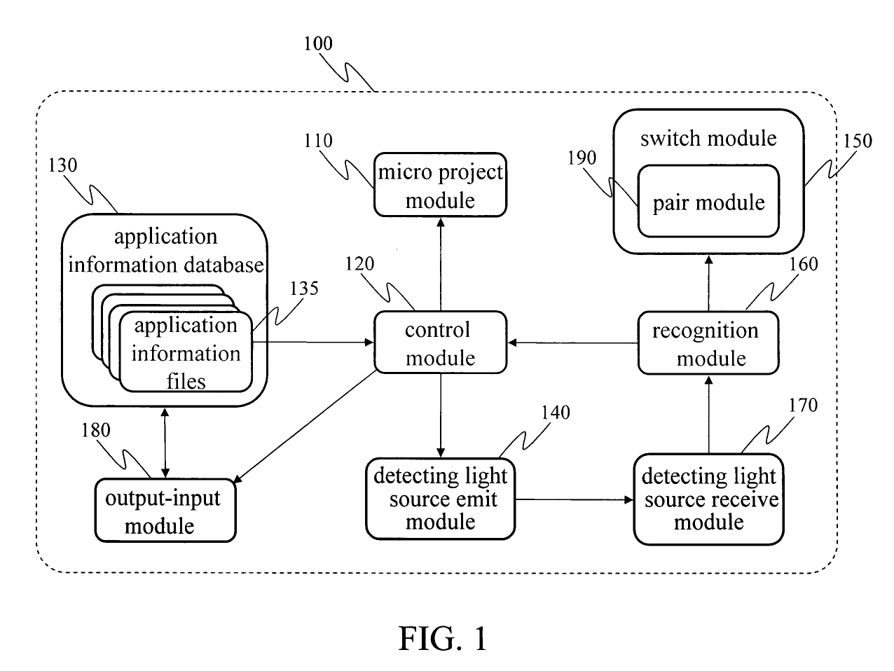

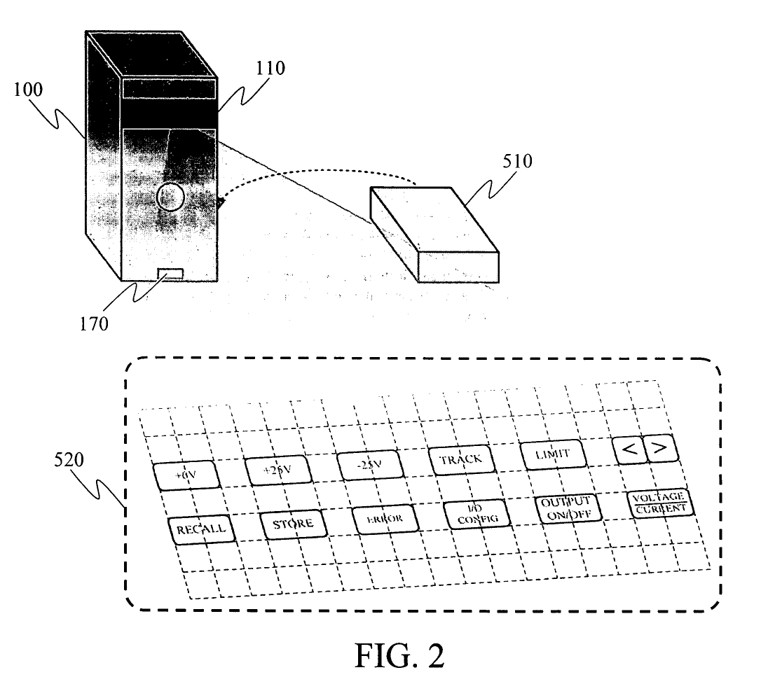

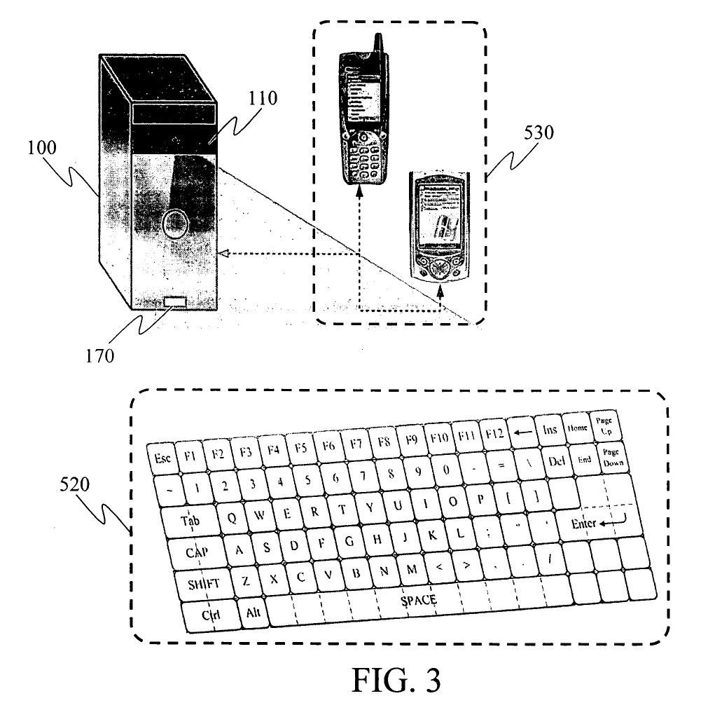

Referring to FIG. 1, it is an architecture view of the system of the present invention which is mainly composed of the following elements: a micro project module 110, which projects input interface images 520 of various master devices or the data such as various texts, pictures. As shown in FIG. 2, when the open virtual input and display device 100 acts as an input device of a multimedia player 510, it projects the input interface image 520 of the multimedia player 510 on the physical plane. As shown in FIG. 3, when the open virtual input and display device 100 acts as the input device of a portable mobile device 530, such as a cell phone, a PDA (Personal Digital Assistant), or a notebook, it projects the corresponding input interface image 520 alternatively, for example, a well-known standard keyboard.

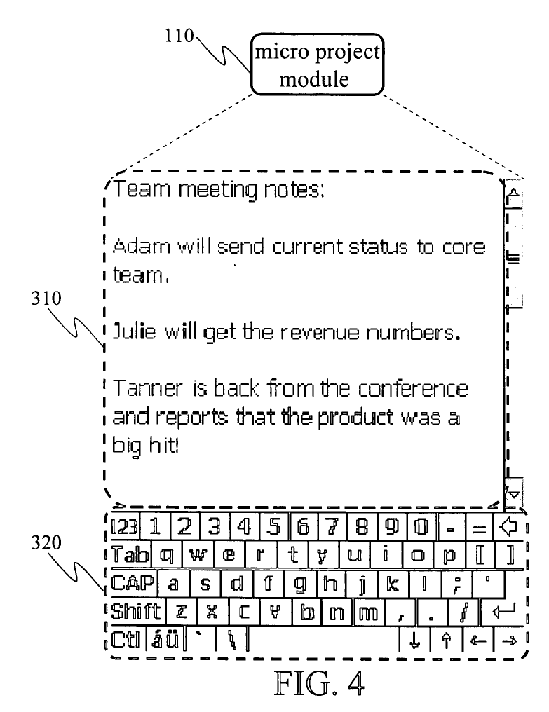

As shown in FIG. 4, it is a display frame of the PDA. the display frame which is originally displayed on the touch screen of the PDA can be projected through the open virtual input and display device 100 by the user when making notes or inputting text, wherein an induction block 320 displays an input keyboard frame for a user to input by clicking or selecting thereon, and projects a detecting beam thereon, so as to detect the input operation command with the reflection of the detecting beam. A display block 310 displays the pages of the electronic book through directly projecting onto the physical plane by the micro-projector, or displays the text input by the user periodically. Therefore, the user can input and browse or edit without taking out the PDA.

If all of the input devices of the master device are integrated into the open virtual input and display device 100 of the present invention, the volume of placing the keyboard input for the master device can be saved and only a pairing key is needed to pair the setup. Meanwhile, some display screens of the master device can be omitted. This results in a small volume of the master device and a low cost of equipping screens, even reduces the number of the remote control of the master device at home.

A control module 120 refers to a CPU (Central Processing Unit) of the open virtual input and display 100, which can be used to activate a project function of a micro project module 110, project the basic menu and the input interface image 520 on the physical plane, read out an application information file 135 of the application information database 130, and set up the recognition function, calculate the detecting beam received by the detecting light source receive module 170 to decide the coordinate position clicked by a finger 280, set up a light color to be displayed when projecting, a size of the projection scope, a resolution degree, a speed and accuracy of the input recognition, and establish a pairing connection with the master devices in frequency hopping.

A switch module 150 is used to recognize a reflective region coordinate sent back through a recognition module 160 according to the setup selected from the basic menu image of the master device by the user, then deliver it to the control unit 120 so as to load the input interface image data of the master device from the application information database 130 and project it, and load the corresponding recognition function. And a pair module 190 is used to cut off the connection with the original master device, and establish the connection together with another master device based upon the original frequency channel when pairing.

The pair module 190 is included in the switch module 150, and is used to pair with the master device when the present system starts. When a pairing key of the master device is pressed down, and at the same time, any one of a blue tooth transmission, a wireless network, a radio is used to search the master device that can be used as a master device input setup hereabout. Here, a pair module 190 is used to send a pairing signal in a specific frequency. The searching is kept on until the open virtual input and display device 100 is found by a master device in the frequency hopping manner. Thereafter, this frequency is taken as the channel for delivering both signals. After the pairing is completed, the pair module 190 adds this frequency and the master device into the paired basic menu thereof.

An output-input module 180 is used to receive the application information file 135 for projecting the master device from the master device. The application information file 135 includes an input interface image 520 data, and is used to recognize the file that is input by a user on the input interface image 520 of the master device, such as a recognition function. Those files are stored in the application information database 130 of a memory, and delivered into the system of the present invention after being edited with a small unit block 260 as the unit by the user through various wire or wireless transmission interfaces, such as a transmission line, a RS-232 network line, or through the way of a memory card, a mobile disk and a blue tooth.

A detecting light source emit module 140 emits an invisible light such as infrared ray, laser to irradiate or scan the scope of the input interface image 520. When the user presses a key, it can irradiate the user's finger 280 and reflect the detecting beam. While, a detecting light source receive module 170 can receive an emit angle and a receive angle of the detecting beam reflected in the range of detection when the finger 280 make the input action on the input interface image 520, and a time difference between emitting and receiving, thereby obtaining a reflective region position clicked by the finger 280 when the input action occurs.

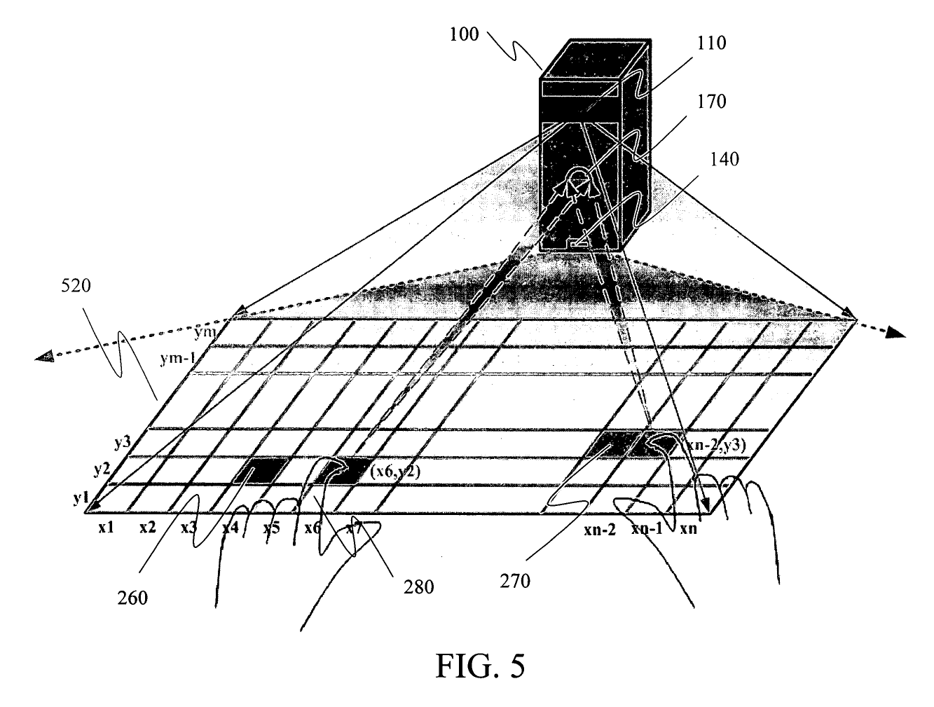

As shown in FIG. 5, when the recognition module 160 receives the position of the user's finger 280 detected by the detecting light source receive module 170, it recognizes the keystroke and position of the user on the frame by utilizing the angle relationship or the time difference between the emitting and receiving of the detecting light source. A low resolution is sufficient to recognize the position of the key, for example, the range which can be detected by the key (i.e. a range of a projection frame) can be cut into a matrix small unit block which has the same size as the finger 280. All of the keys required by the master device are designed with a small unit block as a basic unit. The position of a key only takes up a small unit block 260, or a set of several adjacent small unit blocks 270, which can be designed freely depending on the different requirements from the manufacturer for the product.

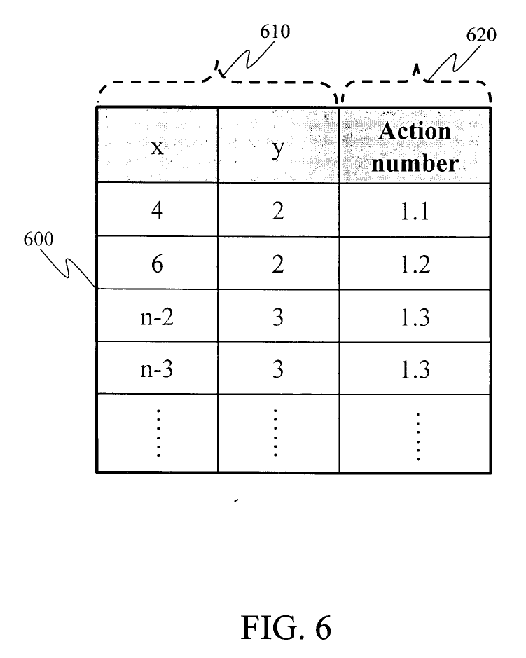

The recognition module 160 is used to calculate and obtain the coordinate value of a small unit block which is clicked by the finger of a user, wherein x1 represents a first section along the x axis of the divided induction area, x2 represents a second section along the x axis of the divided induction area, and the meaning of the x axis number of the other small unit blocks can be derived like this, which is the same for the y axis. The represented operation command is obtained by checking its internal function comparison table 600. As shown in FIG. 6, it is a function comparison table 600 of the master device, including a section coordinate field 610 which is composed of x axis and y axis section of each small unit block 260 of the induction area, and the corresponding represented operation command field 620 when clicking the coordinate position of the small unit block 260.

For example, when the user clicks the small unit block 260 of the input (4,2) coordinates on the input interface image 520, the operation command field of the input interface image 520 can be searched in the function comparison table 600. The resultant “action number” represents that the operation command can be delivered to the control module 120 by switching the master device catalog, so as to drive a micro project module 110 to display the basic menu, which is pair-able to set up the master device, on the physical plane. (n-2,3) and (n-3,3) both corresponding to the same action number means that in the input interface image 520, this area still belongs to a position in which the same icon is located. If it is obtained that the user clicks any of the two small unit blocks 260 by checking the function comparison table 600, which means that the document being edited is stored, the operation command is delivered into the PDA by the output-input module 180, and the actions of storing and editing are carried out.

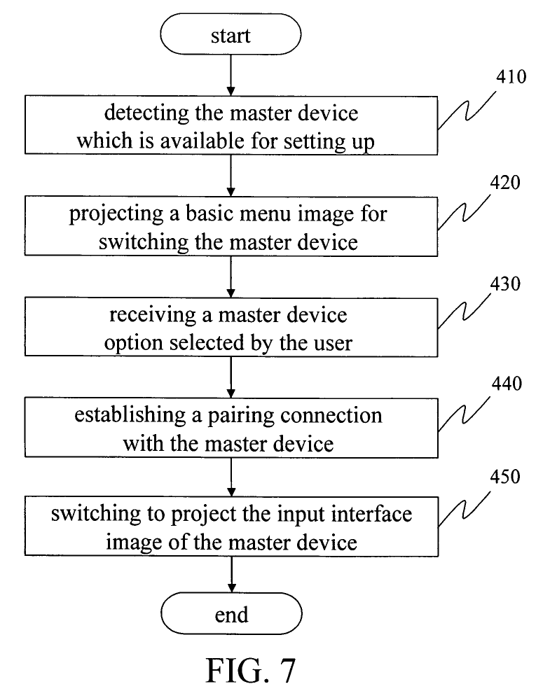

Referring to FIG. 7, it is a flowchart of the method of the present invention for setting up the master device. First the master devices which is available for setting up is detected by a pair module 190.Then the present invention is set up as an input device of each master device by the master device (step 410). A basic menu image of the master devices which are available for the user to select a setup for the input device to be what kind of input device of master device (step 420). Subsequently, an option of the master device selected by the user is received (step 430) and the pairing connection with the master device is established through the frequency channel that is set up by the pair module 190 (step 440). Finally the input interface image 520 of the master device is loaded from an application information database 130 by the switch module 150, and the input interface image 520 of the master device is switched and projected onto the physical plane by the micro project module 110 (step 450).

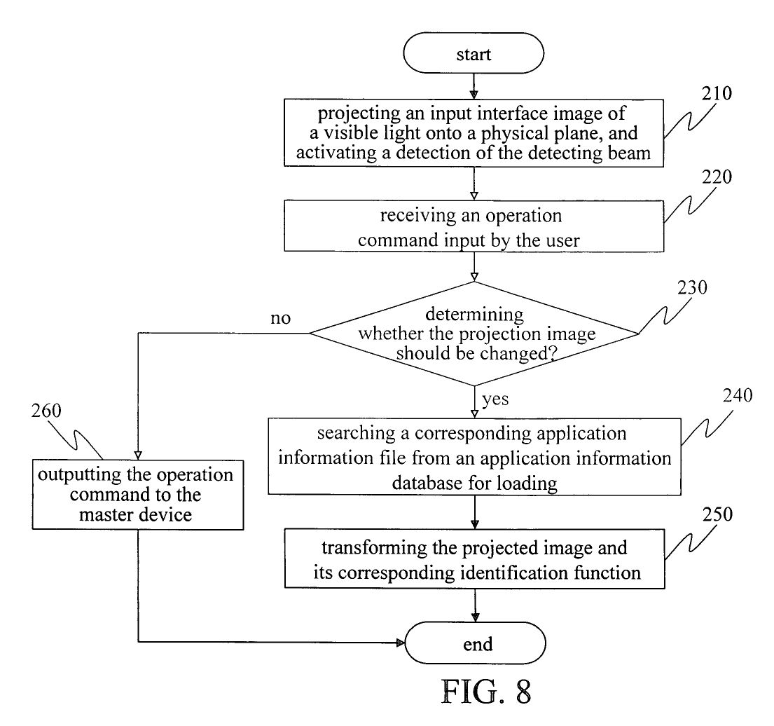

After pairing a variety of master devices, the open virtual input and display device 100 of the present invention is used as an input device of a master device. To achieve the purpose of switching into various virtual devices, please referring to FIG. 8, it is a flowchart of the method of the present invention used as an input device to project, including the following steps. First an input interface image 520 of the master device is projected onto a physical plane by the micro project module 110, and a detecting beam is emitted above the image so as to carry out scanning and detecting (step 210). Subsequently, the detecting beam will be reflect as soon as scanning the user's finger 280 when the user clicks on the input interface image 520, in which the reflected beam is received by the detecting light source receive module 170. Then the clicked position on any of the small unit blocks 260 is calculated. If the reflected clicking range covers multiple small unit blocks 260 and corresponds to various operation commands respectively, the coordinate position must be brought in the recognition function to calculate the possible small unit block 260 to which the position belongs. The operation command input above the image is found by checking the function comparison table 600 of the master device (step 220). After recognizing the instruction input by the user, whether the projection image should be changed by the operation command is determined (step 230).

If the input devices are switched for different master devices, an application information file corresponding to the master device is searched in the application information database 130 and loaded (step 240). A control module 120 is used to control the micro project module 110 to transform the projected input interface image 520 and its corresponding recognition function (step 250). Otherwise, it indicates that the input is still the operation command of the master device. The received operation command is delivered to the master device through the output-input module 180 (step 260), such that the master device takes the corresponding action, for example, when reading an electronic book with the Personal Digital Assistant, the content, such as the image, pattern, and text, is displayed in the display block 310 of the projection image according to the display frame delivered by the Personal Digital Assistant, in the display block of the projection image, while the user interface, such as a input keyboard, a control panel, is displayed in the induction block 320, wherein the user interface includes a key to switch the master device, it is assumed that the original open virtual input and display device 100 is used as an input device of the Personal Digital Assistant for editing the text.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An open virtual input and display device applied to a plurality of master devices as an input and project display device respectively, comprising:
a micro project module for projecting a projection image of a visible light;
a detecting light source emit module for emitting a detecting beam above the projection image for detection;
a detecting light source receive module for receiving a reflected beam of the detecting beam;
a recognition module for determining a keystroke and a coordinate position of the reflective region produced by the keystroke by the reflected beam, and bringing the coordinate position in a recognition function to convert it into an operation command;
an application information database for storing a plurality of application information files;
a control module for controlling the operation of each of the modules and a data delivery, and determining whether the operation command is the switch connection or the delivery to each of the master devices;
a switch module for switching each of the master devices according to the operation command of the switch connection, and loading a projection image data and a recognition function corresponding to the master device from the application information database; and
an output-input module for receiving the input corresponding data of each of the master devices, and outputting the operation commands for each of the master devices.

2. The open virtual input and display device according to claim 1, wherein the recognition function is achieved with a function comparison table.

3. The open virtual input and display device according to claim 2, wherein the function comparison table comprises a coordinate field and an operation command field.

4. The open virtual input and display device according to claim 1, wherein each of the application information files comprises a projection image data and the corresponding recognition function thereof.

5. The open virtual input and display device according to claim 1, wherein the micro project module projects a screen display frame of the master device.

6. The open virtual input and display device according to claim 1, wherein the connection channel is established by a blue tooth transmission, a wireless network, a radio, or any combination thereof.

7. The open virtual input and display device according to claim 1, wherein the coordinate position of the reflective region is calculated with a small unit block as a basic unit.

8. The open virtual input and display device according to claim 1, wherein the switch module further comprise a pair module for recognizing each of the master devices and establishing the setup of a plurality of connection channels to deliver data.

9. The open virtual input and display device according to claim 8, wherein the pair module further comprises a basic menu for recording a plurality of master devices which pairing setup successfully after recognition.

10. The open virtual input and display device according to claim 9, wherein the basic menu further comprises a setup parameter for establishing each of the connection channels with each of the master devices.

11. The open virtual input and display device according to claim 1, wherein the projection image comprises an icon image for switching a catalog of the master devices.

12. A method of an open virtual input and display, which is applied to a plurality of master devices as an input device respectively, the method comprising the steps of:
projecting a projection image of a visible light of a master device onto a physical plane, and emitting a detecting beam above the projection image for detection;
receiving a detecting beam reflected from a reflective region above the projection image by a user;
calculating a coordinate of the reflective region and converting it into an operation command with an recognition function of the master device;
determining the type of the operation command, if the operation command is for switching the master device, then searching a corresponding application information file from an application information database for loading; and
transforming the projected projection image according to the corresponding application information file and loading a corresponding recognition function.

13. The method of an open virtual input and display according to claim 12, wherein if the operation command is an input command of the master device, it will be delivered to the master device, such that the master device takes the corresponding action.

14. The method of an open virtual input and display according to claim 13, wherein the way of the delivery is a blue tooth transmission, a wireless network, a radio, or any combination thereof.

15. The method of an open virtual input and display according to claim 12, wherein the projection image comprises an icon image for switching a catalog of the master device.

16. The method of an open virtual input and display according to claim 12, wherein a coordinate of the reflective region is calculated with a small unit block as a basic unit.

17. The method of an open virtual input and display according to claim 12, further comprising loading the connection setup of the master device, when switching the master device.

18. The method of an open virtual input and display according to claim 17, wherein the establishment of the connection setup of the master device further comprises the steps of:
detecting each of the master devices which is available for setting up;
setting up each of the master devices as an input device;
adding each of the master devices that has been set up to a basic menu; and
storing a plurality of connection setup parameters of each of the master devices.

19. The method of an open virtual input and display according to claim 18, wherein the basic menu can be projected onto a physical plane for the user to select while switching each of the master devices.

20. The method of an open virtual input and display according to claim 12, wherein the basic menu can be displayed by pressing a icon image for switching a catalog of the master device while switching the master device, so as to select and switch.
